(19) United States
(12) Patent Application Publication
(10) Pub. No.: US 2018/0231252 A1
(43) Pub. Date: Aug. 16, 2018

(54) WALL COMPONENT OF A GAS TURBINE WITH IMPROVED COOLING

(71) Applicant: Rolls-Royce Deutschland Ltd & Co KG, Blankenfelde-Mahlow (DE)

(72) Inventor: Carsten Clemen, Blankenfelde-Mahlow (DE)

(21) Appl. No.: 15/882,611

(22) Filed: Jan. 29, 2018

(30) Foreign Application Priority Data
Feb. 10, 2017 (DE) 10 2017 202 177.2

(51) Int. Cl. F23R 3/06; F23R 3/00; F02K 3/06

(52) U.S. Cl. CPC F23R 3/06; F23R 3/005; F02K 3/06; F05D 2260/31; F05D 2220/323; F05D 2240/35; F23R 2900/03041

(57) ABSTRACT

A wall component of a combustion chamber arrangement, including a wall area with a side that is facing towards the combustion chamber and a side that is facing away from the combustion chamber, a plurality of first effusion cooling holes connecting the side that is facing away from the combustion chamber to the side that is facing towards the combustion chamber by means of exactly one through channel, and at least one modified second effusion cooling hole with a main channel and a branching channel, wherein the modified second effusion cooling hole has a common entry opening and a common exit opening.

This application claims priority to German Patent Application DE102017202177.2 filed Feb. 10, 2017, the entirety of which is incorporated by reference herein.

### DESCRIPTION

The present invention relates to a wall component of a combustion chamber arrangement of a gas turbine, in particular of an aircraft gas turbine, with an improved cooling.

Combustion chambers of gas turbines are known from the state of the art in different embodiments. Here, it is known to insert a plurality of so-called effusion cooling holes into a wall component so as to cool the wall component. In this manner, a cooling air film can be applied to the wall area on the hot side of the wall component, i.e. the side that is facing towards the combustion chamber. In order to prevent any thermal damage to the wall component, the applied cooling air film should be provided to be as uniform as possible at the side of the wall component that is facing towards the combustion space. The cooling air holes are supplied with cooling air from the side that is facing away from the combustion space. The cooling air holes can for example be created by means of laser drilling or electrical discharge machining (EDM). The cooling holes themselves usually have a diameter in the order of magnitude of smaller than 2 mm, and can be formed so as to be either perpendicular with respect to the surface or inclined with respect to the surface. However, there are also additional devices or installations that are arranged in the wall component of the combustion chamber, such as for example admixing holes that are arranged in the form of a larger opening inside the wall component, or threaded bolts or the like for affixing the wall component. However, here it is of course not possible to provide effusion cooling holes at these devices in the wall area. As a result, due to reasons of space, there are always areas at the wall component that cannot be cooled by means of effusion cooling holes. Further, the arrangement of such devices at the side that is facing away from the combustion space also renders an efficient incident flow to the effusion cooling holes more difficult, so that additional cooling air has to be provided, which in that case is no longer available for mixing and thus for emission control via the admixing holes.

Therefore, it is the objective of the present invention to provide a wall component of a combustion chamber arrangement of a gas turbine which, while having a simple structure and being easy and cost-effective to manufacture, facilitates efficient cooling by means of effusion cooling holes, even if various devices are arranged at the wall component.

This objective is achieved through a wall component with the features of claim 1, with preferred further developments of the invention being specified in the subclaims.

By contrast, the wall component of a combustion chamber arrangement of a gas turbine, in particular of an aircraft gas turbine, according to the invention has the advantage that, in particular at areas of the wall component that are located behind such devices as seen in flow direction, sufficient cooling is possible even if additional installations or devices or the like are present. Here, the wall component has a wall area with a side that is facing towards the combustion space and a side that is facing away from the combustion space. What is further provided is a plurality of first effusion cooling holes that connect the side that is facing away from the combustion space with the side that is facing towards the combustion space by means of exactly one through channel, as well as at least one modified second effusion cooling hole with a main channel and a branching channel. Here, the modified second effusion cooling hole has exactly one entry opening and exactly one exit opening. In other words, the main channel and the branching channel of the modified second effusion cooling hole have a common entry opening at the side that is facing away from the combustion space and a common exit opening at the side that is facing towards the combustion space. Thus, by providing a branch in the effusion cooling hole, the branch can be passed inside the wall component in such a manner that the branch cools areas of the wall component which are provided without an effusion cooling hole due to considerations regarding the installation space. In this manner, an improved cooling can be achieved also in areas that are arranged behind a device or the like in the flow direction. The branching channel thus branches off from the main channel and leads back into in main channel again before the main channel comes out at the exit opening to the combustion chamber.

It is further preferred that, with respect to the branching channel, the main channel is arranged in the flow direction downstream of the branching channel. Thus, the branching channel can be passed close to uncooled areas adjacent to a device in the wall component.

It is particularly preferable if a cross section of the exit opening of the modified second effusion cooling hole is greater or equal to a sum of a minimum first cross section of the main channel and a minimum second cross section of the branching channel. In this manner, a continuous flow through the main channel and the branching channel is ensured.

It is further preferred that the wall component comprises a device, in particular an admixing air hole or a threaded bolt for affixing the wall component. At that, the modified second effusion cooling hole is arranged adjacent to the device. It is particularly preferable if the modified second effusion cooling hole is arranged downstream of the device in the flow direction. In this manner, the branching channel can be passed into the areas that are located behind the device in flow direction, and can cool these areas.

It is particularly preferable if a first cross section of the main channel and a second cross section of the branching channel respectively remain constant in the through-flow direction.

The main channel is preferably embodied in a linear manner. As a result, the main channel of the modified second effusion cooling hole has the same cooling capacity as the first effusion cooling holes if these are also embodied in a linear manner.

It is particularly preferable if the maximum first cross section of the main channel is larger than the maximum second cross section of the branching channel. In this manner it is ensured that the greater part of the air mass flows through the main channel in the course of the cooling process.

The main channel is preferably provided at the side that is facing towards the combustion chamber so as to be inclined at an acute angle to a surface of the wall component in the direction of the through-flow direction.

It is to be understood that the main channel can be embodied in a linear manner, or it can be passed in a curved manner through the wall component.

It is further preferred that a distance A of a device that is provided in the wall component from a point of the device that is located furthers downstream to an exit opening of a modified second effusion cooling hole is determined by the equation:

A=x/2+x tan a

Here, a is a mean hole inclination angle of a straight connecting line between a central point of the inlet opening and a central point of the outlet opening of the modified second effusion cooling hole, and x is a wall thickness of the wall component. The hole inclination angle is preferably in a range of 15°≤a≤45°, preferably being 20°. The wall thickness x is preferably in a range of 0<x≤3 mm, particularly preferably being 1.5 mm. Based on this distance A, preferably a rectangle or a trapezoid or a triangle with no exit openings of effusion cooling holes arranged therein can be defined. However, branched channels of the modified second effusion cooling holes can be passed through this area defined by the distance A in order to be able to also cool this area downstream of the device.

It is particularly preferable if the wall component is an additive component that is manufactured by means of an additive manufacturing method.

It is further preferred if the exit opening is larger than the entry opening.

It is further preferred if multiple second effusion cooling holes are arranged adjacent to the device that is provided at the wall component, such as for example an admixing hole.

Further, the present invention relates to a gas turbine, in particular to an aircraft gas turbine, with a wall component of a combustion chamber arrangement according to the invention. Further, the wall component preferably is a shingle of a combustion chamber of a gas turbine. Here, the combustion chamber can be preferably embodied with one wall or with a double wall.

In the following, preferred exemplary embodiments of the invention are described in detail by referring to the accompanying drawing. Herein:

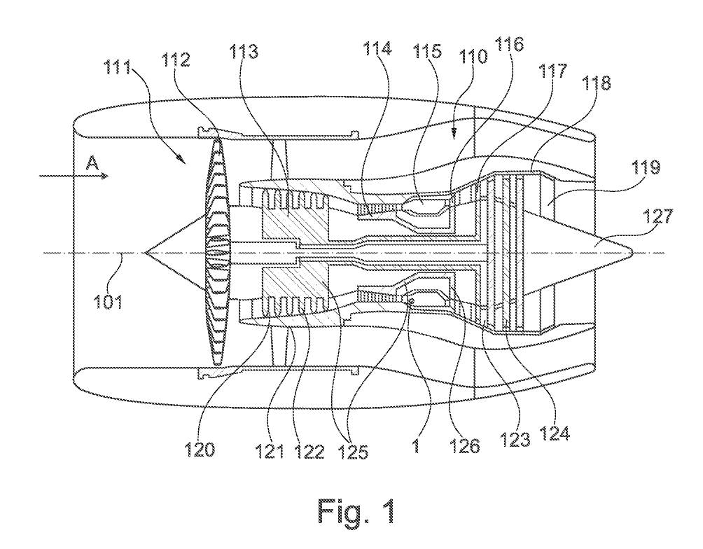

FIG. 1 shows a gas turbine engine with a wall component of a combustion chamber arrangement according to the invention,

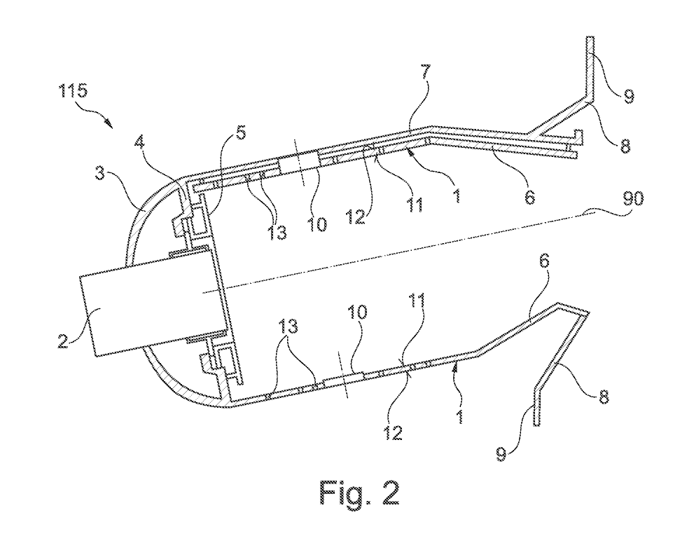

FIG. 2 shows a schematic sectional view of a combustion chamber arrangement, in which a wall component according to the invention can be used, wherein a double-walled combustion chamber arrangement is shown in the top part of FIG. 2, and a single-wall combustion chamber arrangement is shown in the bottom part of FIG. 2,

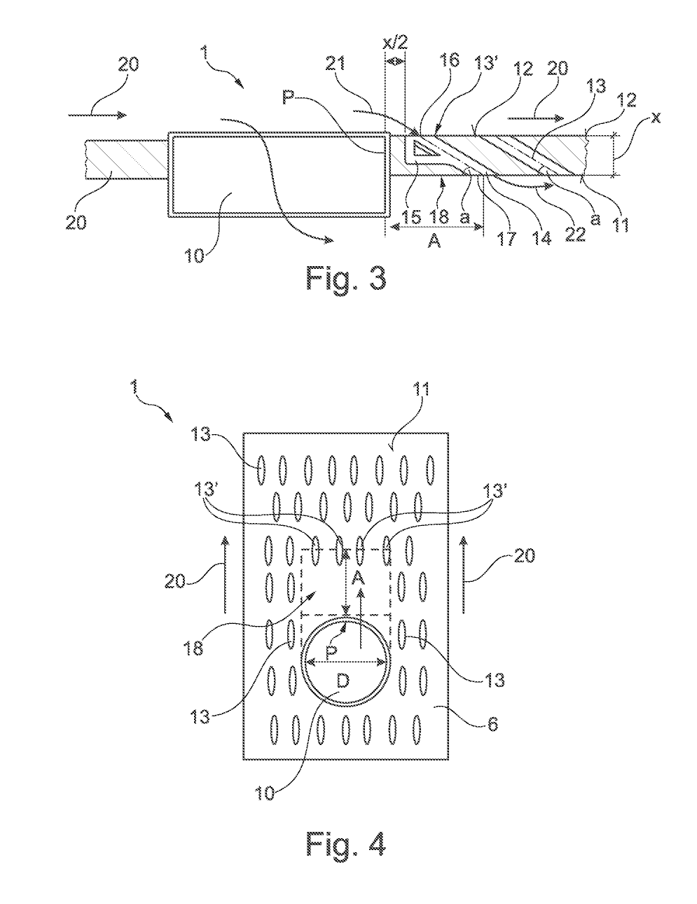

FIG. 3 shows a schematic sectional view of a single-wall combustion chamber arrangement according to a first exemplary embodiment of the invention,

FIG. 4 shows a schematic top view of the side of the wall component of FIG. 3 that is facing towards the combustion chamber,

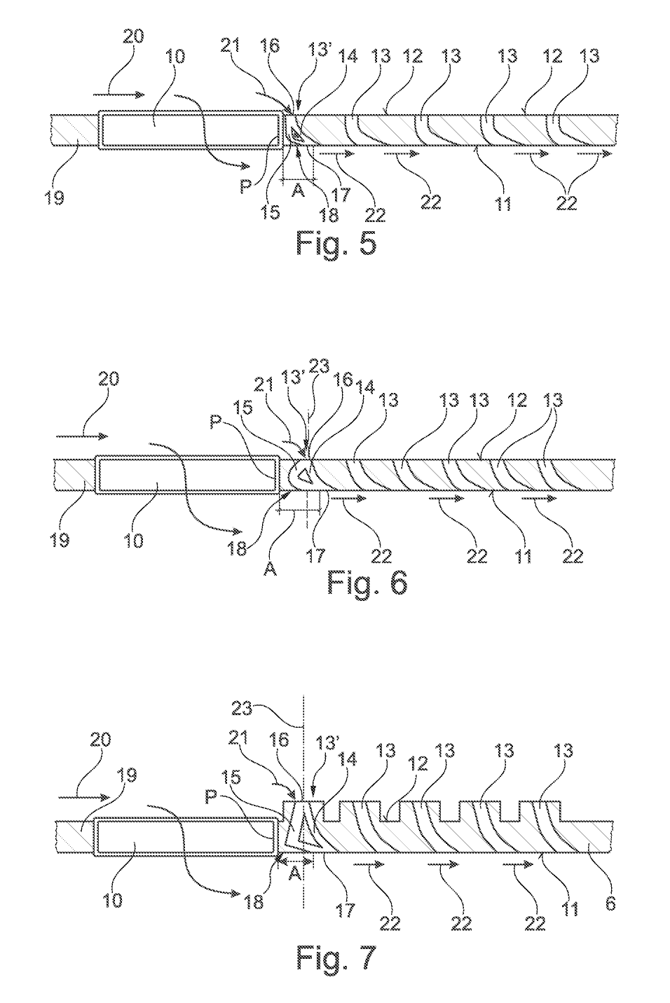

FIG. 5 shows a schematic sectional view of a wall component according to a second exemplary embodiment of the invention,

FIG. 6 shows a schematic sectional view of a wall component according to a third exemplary embodiment of the invention,

FIG. 7 shows a schematic sectional view of a wall component according to a fourth exemplary embodiment of the invention, and

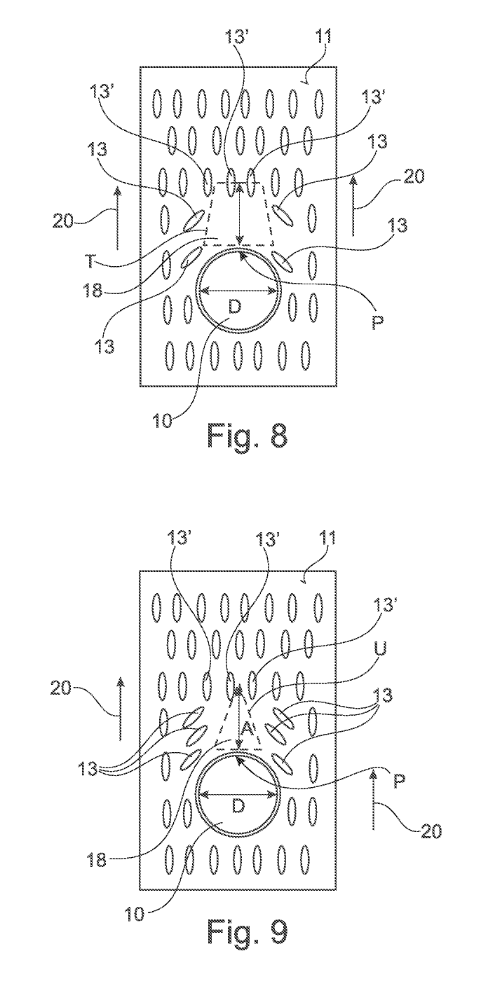

FIGS. 8 and 9 show schematic renderings of sides of the wall components that are facing towards the combustion chamber with two examples of a possible extension of areas downstream of a device in the wall component at which the modified second effusion cooling holes according to the invention may be used.

The gas turbine engine 110 according to FIG. 1 represents a general example of a turbomachine in which the invention may be used. The engine 110 is configured in a conventional manner and comprises, arranged successively in flow direction, an air inlet 111, a fan 112 that rotates inside a housing, a medium-pressure compressor 113, a high-pressure compressor 114, a combustion chamber 115, a high-pressure turbine 116, a medium-pressure turbine 117, and a low-pressure turbine 118 as well as an exhaust nozzle 119, which are all arranged around a central engine axis 101.

The medium-pressure compressor 113 and the high-pressure compressor 114 respectively comprise multiple stages, of which each has an arrangement of fixedly arranged stationary guide vanes 120 that are generally referred to as stator vanes and project radially inward from the core engine housing 121 through the compressors 113, 114 into a ring-shaped flow channel. Further, the compressors have an arrangement of compressor rotor blades 122 that project radially outward from a rotatable drum or disc 125, and are coupled to hubs 126 of the high-pressure turbine 116 or the medium-pressure turbine 117.

The turbine sections 116, 117, 118 have similar stages, comprising an arrangement of stationary guide vanes 123 projecting radially inward from the housing 121 through the turbines 116, 117, 118 into the ring-shaped flow channel, and a subsequent arrangement of turbine blades/vanes 124 projecting outwards from the rotatable hub 126. During operation, the compressor drum or compressor disc 125 and the blades 122 arranged thereon as well as the turbine rotor hub 126 and the turbine rotor blades/vanes 124 arranged thereon rotate around the engine axis 101.

FIG. 2 shows two possible embodiments of a combustion chamber 115. The top part of FIG. 2 shows, above a center line 90 of the combustion chamber 115, a double-walled construction with an outer wall 7 and inner wall 6 is shown, while the bottom part of FIG. 2 shows a single-wall construction with only one wall 6 (below the center line 90). The combustion chamber 115 comprises a fuel nozzle 2, a combustion chamber head 3, a head plate 4, and a heat shield 5. The reference sign 8 indicates a combustion chamber suspension, which may comprise a flange 9. A plurality of effusion cooling holes 13 is respectively shown in the wall 6 that is closest to the combustion chamber. Here, the wall 6 that is closest to the combustion chamber represents a wall component 1 according to the invention that is schematically shown in FIGS. 3 and 4.

FIG. 3 shows, in a schematic manner, a sectional view through a wall component 1 of the combustion chamber 115. The wall component has a thickness x, and may for example a combustion chamber shingle.

The wall component 1 comprises a wall area 19 with a side 11 that is facing towards the combustion chamber and a side 12 that is facing away from the combustion chamber. The side 11 that is facing towards the combustion chamber is also known as the hot side, and the side that is facing away from the combustion chamber is also referred to as the cold side.

The wall component 1 further comprises a plurality of first effusion cooling holes 13 that connect the side 11 that is facing away from the combustion chamber to the side 12 that is facing towards the combustion chamber by means of exactly one through channel.

The wall component 1 further comprises at least one modified second effusion cooling hole 13′ that comprises a main channel 14 and a branching channel 15. Here, the modified second effusion cooling hole 13′ has a common entry opening 16 and a common exit opening 17.

In this manner, a second effusion cooling hole 13′ is provided that is formed in a modified manner and has a branching channel 15 in addition to the main channel 14. The branching channel 15 branches off from the main channel 14 and leads back into the same before the main channel opens at the exit opening 17 at the side 11 that is facing towards the combustion chamber.

As can be seen in FIG. 3, the modified second effusion cooling hole 13′ is arranged directly adjacent to a device 10 in the wall component 1. In this exemplary embodiment, the device 10 is an admixing air hole. Since the admixing air hole does not allow for effusion cooling holes to be provided in the area of the admixing air hole, what results is an area 18 without exit openings in the flow direction 20 at the side that is facing towards the combustion chamber 11. As shown in FIG. 4, the area without exit openings has a square shape in this exemplary embodiment, wherein the area 18 is determined by a point P of the device 10 that is located furthest downstream in the flow direction 20. The device 10 that is embodied as an admixing hole has a diameter D, and slightly projects into the combustion space. At that, the distance A to the exit openings of the effusion cooling holes 13 that are located closest to the point P in the flow direction 20 is calculated by means of the following equation:

A=x/2+x tan a,

wherein a is the angle of the effusion cooling hole relative to the side 11 that is facing towards the combustion chamber, and x is the thickness of the wall component.

As can be seen in FIG. 3, the entry opening 16 is arranged at a distance of x/2 to the point P of the device 10.

In order to also facilitate a sufficient cooling of the area 18, four modified second effusion cooling holes 13′ are provided downstream adjacent to the device 10 in this exemplary embodiment. As can be seen in FIG. 3, the branching channel 15 of each modified second effusion cooling hole 13′ is provided in such a manner that the branching channel 15 is arranged as close as possible to the device 10 and as close as possible to the area 18. In this manner, areas that are arranged directly behind the device 10 in the flow direction 20 can be cooled by means of the branching channel 15. In this manner, a temperature of areas of the wall component 1 located behind the obstacles or devices 10 in the flow direction 20 can also be efficiently reduced.

As can further be seen from FIG. 4, four modified second effusion cooling holes 13′ are provided, efficiently cooling the area 18 without exit openings that is arranged behind the device 10 in the through-flow direction. Here, a relatively long cooling zone can be obtained in the area 18 due to the right angle in the branching channel 15.

As can be seen in FIG. 3, in the modified second effusion cooling hole 13′, a diameter of the main channel 14 has the same size as a normal diameter of a first effusion cooling hole 13. Thus, the cooling capacity of the main channel 14 can be as high as that of a first effusion cooling hole 13.

The wall component 1 is preferably manufactured by means of an additive method, so that the modified second effusion cooling holes 13′ can be manufactured in a manner that is as simple and cost-effective as possible.

FIGS. 8 and 9 show alternative embodiments of the wall component 1 according to the invention. In FIG. 8, three modified second effusion cooling holes 13′ are arranged in such a manner that the area 18 has a trapezoid shape T behind the device 10 in the through-flow direction 20. As can be seen in FIG. 8, in total three modified second effusion cooling holes 13′ are provided directly adjacent to the device 10. The rest of the effusion cooling holes 13 are provided as single-channel effusion cooling holes. FIG. 9 shows an alternative design, in which the area 18 without exit openings has a triangular shape U. At that, in total three modified second effusion cooling holes 13′ are provided adjacent to the device 10.

A shown in FIG. 3, an improved cooling of areas 18 located behind a device 10 in the flow direction 20, such as for example an admixing hole, can be facilitated in this manner. Here, cooling air flows into the entry opening 16 and then flows through the main channel 14 as well as through the branching channel 15, as indicted in FIG. 3 by arrow 21. The two air flows through the main channel 14 and the branching channel 15 are united again through the exit opening 17, and are subsequently discharged in the form of a cooling air film at the side 11 of the wall component 1 that is facing towards the combustion chamber, as indicated in FIG. 3 by arrow 22.

At that, the branching channel 15 is arranged as close as possible to the area 18 without exit openings to facilitate improved cooling of this area 18.

As shown in FIG. 3, the main channel 14 and the branching channel 15 are located in a common plane that is perpendicular to the wall component 1. Here, the branching channel has a right angle, so that a relatively long portion of the branching channel 15 is passed in parallel to the side 11 that is facing towards the combustion chamber, so that the area 18 can be optimally cooled. Further, the main channel 14 is arranged downstream of the branching channel in the flow direction 20.

FIG. 5 shows a wall component 1 according to a second exemplary embodiment of the present invention. In contrast to the first exemplary embodiment, in the second exemplary embodiment, the branching channel 15 is embodied in a curved manner, with the main channel 14 also being embodied in a curved manner. This results in reduced losses when the flow passes through the modified second effusion cooling holes 13′. As can be seen in FIG. 5, the other first effusion cooling holes 13 are likewise embodied in a curved manner.

FIG. 6 shows a third exemplary embodiment of a wall component 1, wherein, in contrast to the second exemplary embodiment, in the third exemplary embodiment the branching channel 15 has a partial area that extends counter to the flow direction 20, and thus reaches close to the device 10. As schematically shown in FIG. 6, the branching channel 15 is located at least partially upstream of the vertical 23 to the wall component, so that cooling is facilitated as close as possible to the device 10.

FIG. 7 shows a wall component 1 according to a fourth exemplary embodiment of the invention. The wall component of the fourth exemplary embodiment substantially corresponds to that of the third exemplary embodiment, wherein, in contrast to the latter, the branching channel 15 is formed with a right angle. In this manner, an improved cooling of the area 18 at side 11 can be achieved.

### PARTS LIST

1 wall component
2 fuel nozzle
3 combustion chamber head
4 head plate
5 heat shield
6 inner combustion chamber wall
7 outer combustion chamber wall
8 combustion chamber suspension
9 flange
10 device
11 side facing towards the combustion chamber
12 side facing away from the combustion chamber
13 first effusion cooling hole
13′ modified second effusion cooling hole
14 main channel
15 branching channel
16 entry opening
17 exit opening
18 area without exit openings
19 wall area
20 flow direction
21 Lufteintritt
22 Luftaustritt
23 Senkrechte
101 engine central axis
110 gas turbine engine/core engine
111 air inlet
112 fan
113 medium-pressure compressor (compactor)
114 high-pressure compressor
115 combustion chamber
116 high-pressure turbine
117 medium-pressure turbine
118 low-pressure turbine
119 exhaust nozzle
120 guide vanes
121 core engine housing
122 compressor rotor blades
123 guide vanes
124 turbine blades/vanes
125 compressor drum or compressor disc
126 turbine rotor hub
127 outlet cone
A distance between the device and the exit opening of the modified second effusion cooling hole
D diameter of the admixing air hole
P point of the device 10 located furthest downstream
T trapezoid shape
U triangular shape
x thickness of the wall component
a acute angle of the exit of the modified second effusion cooling hole

1. A wall component of a combustion chamber arrangement, comprising
a wall area with a side that is facing towards the combustion chamber and a side that is facing away from the combustion chamber,
a plurality of first effusion cooling holes connecting the side that is facing away from the combustion chamber to the side that is facing towards the combustion chamber by means of exactly one through channel, and
at least one modified second effusion cooling hole with a main channel and a branching channel,
wherein the modified second effusion cooling hole has a common entry opening and a common exit opening.

2. The wall component according to claim 1, wherein the main channel is arranged at the wall component downstream of the branching channel in the flow direction.

3. The wall component according to claim 1, wherein a cross section of the exit opening is greater or equal to a sum of the minimum cross sections of the main channel and of the branching channel.

4. The wall component according to claim 1, further comprising a device, wherein the modified second effusion cooling hole is arranged adjacent to the device, in particular downstream of the device.

5. The wall component according to claim 4, wherein the device is an admixing air hole which passes through the wall component, or a threaded bolt for affixing the wall component at the side that is facing away from the combustion chamber.

6. The wall component according to claim 1, wherein a first cross section of the main channel and a second cross section of the branching channel remain constant in the through-flow direction.

7. The wall component according to claim 1, wherein the main channel is embodied in a linear manner, or wherein the main channel is embodied in a curved manner.

8. The wall component according to claim 1, wherein the maximum first cross section of the main channel is larger than the maximum second cross section of the branching channel.

9. The wall component according to claim 1, wherein the main channel exits from the wall component at an acute angle with respect to the side that is facing towards the combustion chamber.

10. The wall component according to claim 1, wherein the branching channel has a right angle.
